(19) United States
(12) Patent Application Publication
(10) Pub. No.: US 2021/0255820 A1
(43) Pub. Date: Aug. 19, 2021

(54) PRESENTATION OF AUDIO CONTENT AT VOLUME LEVEL DETERMINED BASED ON AUDIO CONTENT AND DEVICE ENVIRONMENT

(71) Applicant: Lenovo (Singapore) Pte. Ltd., Singapore (SG)

(72) Inventors: Mark Patrick Delaney, Raleigh, NC (US); Nathan J. Peterson, Oxford, NC (US); Russell Speight VanBlon, Raleigh, NC (US); Arnold S. Weksler, Raleigh, NC (US); John Carl Mese, Cary, NC (US)

(21) Appl. No.: 16/793,739

(22) Filed: Feb. 18, 2020

(51) Int. Cl. G06F 3/16; G06K 9/00; H04N 21/439; G10L 15/22

(52) U.S. Cl. CPC G06F 3/165; G06F 3/167; G06K 2009/00322; H04N 21/4396; G10L 15/22; G06K 9/00221

(57) ABSTRACT

In one aspect, a device may include at least one processor and storage accessible to the at least one processor. The storage may include instructions executable by the at least one processor to access, at a device, first audio content. The instructions may also be executable to determine at least a first parameter related to the first audio content and, based on at least the first parameter, determine a first volume level at which to present the first audio content. The instructions may also be executable to present, using the device, the first audio content at the first volume level.

### FIELD

The present application relates to technically inventive, non-routine solutions that are necessarily rooted in computer technology and that produce concrete technical improvements.

### BACKGROUND

As recognized herein, when a user commands his or her smart phone or other device to present media such as audio video (AV) content, the volume level at which the media is presented is typically a static, predetermined volume level that might be too high or too low. There are currently no adequate solutions to the foregoing computer-related, technological problem.

### SUMMARY

Accordingly, in one aspect a device includes at least one processor and storage accessible to the at least one processor. The storage includes instructions executable by the at least one processor to access audio content, determine a first parameter related to the audio content and a second parameter related to the environment in which the device is currently disposed, and determine a volume level at which to present the audio content based on the first and second parameters. The instructions are then executable to present, using the device, the audio content at the volume level.

In some implementations, the instructions may be executable to determine the first parameter by analyzing words used in the audio content. So, for example, the first parameter may be related to use of profanity as determined at least in part based on the analysis of words used in the audio content, the second parameter may be related to a child being present as determined based on input from a camera, and the volume level may be determined to be zero based at least in part on the use of profanity and the child being present.

However, additionally or alternatively the second parameter may be related to a current ambient noise level, the presence of at least one other person, the presence of at least one child specifically, and/or the presence of a particular person identified by the device via facial recognition. The second parameter may also be related to the device being disposed in a public place or a non-public place. Additionally or alternatively, the second parameter may be related to the lack of people, other than a user, within a threshold distance to the device, where the volume level may be determined to be a particular level preset by the user based on the lack of people.

In another aspect, a method includes accessing audio content at a device, determining at least a first parameter related to the audio content, and determining a volume level at which to present the audio content based on the first parameter. The method also includes presenting, using the device, the audio content at the volume level.

In some examples, the first parameter may be related to use of profanity in the audio content, reference to sexual acts in the audio content and/or sexual topics in the audio content, and/or use of violent language in the audio content and/or references to violence in the audio content.

Also, in some implementations the method may include determining a second parameter related to the environment in which the device is currently disposed. The second parameter may be related to the presence of at least one person below a predetermined age threshold, and/or related to the device being disposed in a public place.

In still another aspect, at least one computer readable storage medium (CRSM) that is not a transitory signal includes instructions executable by at least one processor to access first audio content at a device, determine at least a first parameter related to the first audio content, and determine a first volume level at which to present the first audio content based on at least the first parameter. The instructions are also executable to present, using the device, the first audio content at the first volume level.

In some implementations, the instructions may be executable to access second audio content while the device is disposed at a same geographic location as the device was at when the first audio content was accessed, where the second audio content may be accessed at a second time adjacent to a first time at which the first audio content was accessed. In these implementations, the instructions may then be executable to determine at least a second parameter related to the second audio content and, based on at least the second parameter, determine a second volume level at which to present the second audio content. The second volume level may be different than the first volume level. In these implementations, the instructions may then be executable to present, using the device, the second audio content at the second volume level.

For example, the first parameter may be related to use of profanity, the second parameter may be related to non-use of profanity, the first volume level may be zero, the second volume level may be more than zero, and the first and second audio contents may both be presented using the device at respective times during which a particular person other than a user is determined to be present.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3 and 4 show flow charts of example algorithms that may be used consistent with present principles to determine a volume level at which to present audio content;

FIG. 5 shows an example graphical user interface (GUI) that may be presented on a display prior to a device presenting audio content based on the device determining that sensitive language is used in the audio content; and

FIG. 6 shows an example GUI for configuring one or more settings of a device operating consistent with present principles.

### DETAILED DESCRIPTION

The present application discloses, among other things, systems and methods for launching media with an audio level that is dynamically determined at media launch based on the media/content itself, the audience, and/or the ambient noise in an environment in which the device is located.

So, for example, if a user receives a first video using a lot of profanity and the user is at a restaurant with people from his/her work, the system may recognize the content of the media and recognize the profile of the people in the proximity of the user to determine that the volume should be muted for playback of the first video. But if the user's device were to then, at an adjacent time, access another video with no profanity while still at the same restaurant and with the same people still present, the device may determine that the volume level may be a preset level higher than zero for playback of the second video.

As another example, if the user receives the same profane video but is at home alone sitting on the couch, the system may recognize the content of the media and recognize the lack of other people being within the proximity to the user and so the system may determine that the volume level for the video should be set at medium.

As yet another example, if the user receives the same profane video while the user is sitting next to his/her brother in a car, the system may recognize the content of the media and recognize the profile of the brother that is proximate to the user and so the system may determine that the volume level for the video should be set at high.

Additionally, note that if a person other than the user is determined to be present while the media is being presented with audio content muted, but then that other person leaves the vicinity of the device while the audio content is muted as determined by the system itself, the system may un-mute the audio content during/in the middle of playback without additional input from the user to do so in order to present it at a volume level greater than zero.

Furthermore, in addition to words used in the audio component of the video itself as well as the presence of any people other than the user, a microphone on the system may be used to determine ambient noise in the environment in which the device is disposed and then the device may further adjust the launch volume up or down to compensate for ambient noise.

Thus, in some implementations the system may cache the media about to be played to understand the audio content through voice recognition to then decide on audio appropriateness relative to the audience or potential audience. Location/proximity detection may be leveraged to determine the audience while facial recognition may also be leveraged to further increase confidence of the audience recognition. Microphones may also be leveraged to determine ambient noise, and then volume level may be dynamically adjusted up or down and the media may be presented accordingly.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to hypertext markup language (HTML)-5, Java/JavaScript, C # or C++, and can be stored on or transmitted from a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

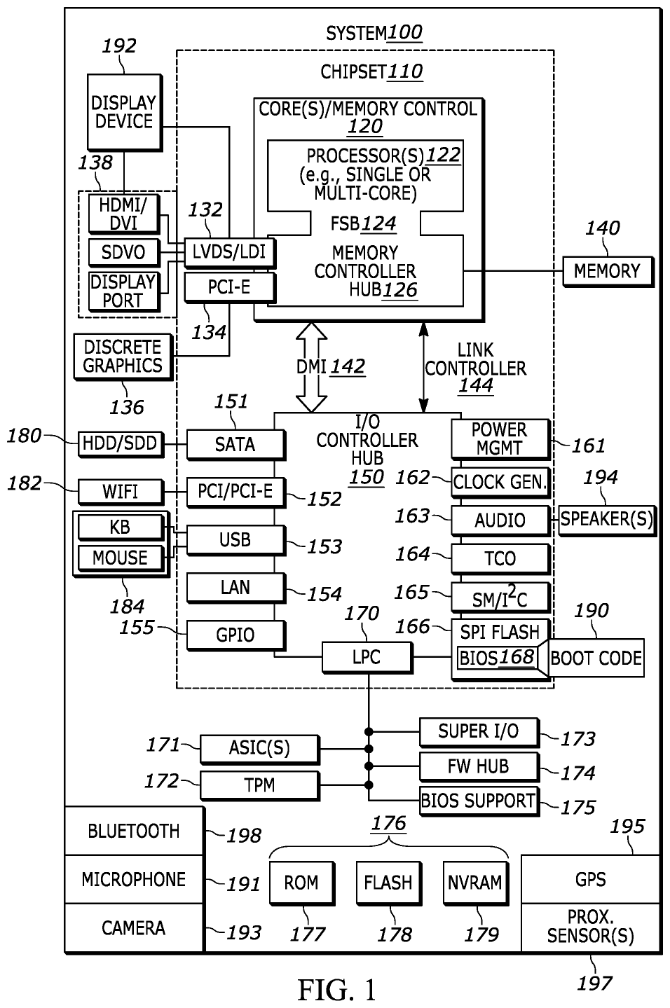

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

The system 100 may also include an audio receiver/microphone 191 that provides input from the microphone 191 to the processor 122 based on audio that is detected, such as ambient noise sensed by the microphone 191 consistent with present principles. The system 100 may also include a camera 193 that gathers one or more images and provides input related thereto to the processor 122. The camera 193 may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video.

Also, the system 100 may include a global positioning system (GPS) transceiver 195 that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

As also shown, one or more proximity sensors 197 such infrared (IR) proximity sensors, laser rangefinders, etc. may be disposed on the system 100. If an IR proximity sensor is used, it may include one or more IR light-emitting diodes (LEDs) for emitting IR light as well as one or more photodiodes and/or IR-sensitive cameras for detecting reflections of IR light from the LEDs off of a user's body back to the IR proximity sensor. The time of flight and/or detected intensity of the IR light reflections may then be used to determine the distance from an object off which the IR light reflects to the system 100 itself using a relational database that correlates respective times of flight and/or intensities with respective distances. Note that radar transceivers and/or sonar/ultrasound transceivers and associated algorithms may similarly be used.

In implementations where a laser rangefinder establishes the at least one sensor 197, the laser rangefinder may include both a laser for emitting coherent light as well as one or more photodiodes and/or cameras sensitive to the laser light used by the rangefinder (e.g., visible light, IR light, ultraviolet light, etc.) for detecting reflections of the laser light from the laser off of an object proximate to the system 100. The rangefinder itself and/or the processor(s) 122 may then calculate the time of flight for laser light to be emitted from the laser and reflected back to the photodiodes/cameras to determine distance to a person consistent with present principles.

As also shown in FIG. 1, the system 100 may include a Bluetooth transceiver and/or other short-range wireless communication transceiver 198 for use consistent with present principles. The Bluetooth communication transceiver 198 may be a classic Bluetooth transceiver and/or a Bluetooth low energy (BLE) transceiver (e.g., Bluetooth 5.0 transceiver) for communicating with other devices using Bluetooth communication protocols. Additionally, as alluded to above the transceiver 198 may also be configured for communication using other protocols as well and may therefore establish a Zigbee transceiver, Z-wave transceiver, near field communication (NFC) transceiver, infrared transceiver, a Wi-Fi direct transceiver, and/or wireless universal serial bus (USB) transceiver.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further,

It is to be understood that an example client device or other machine/computer may include fewer or more features than shown on the system 100 of FIG. 1. In any case, it is to be understood at least based on the foregoing that the system 100 is configured to undertake present principles.

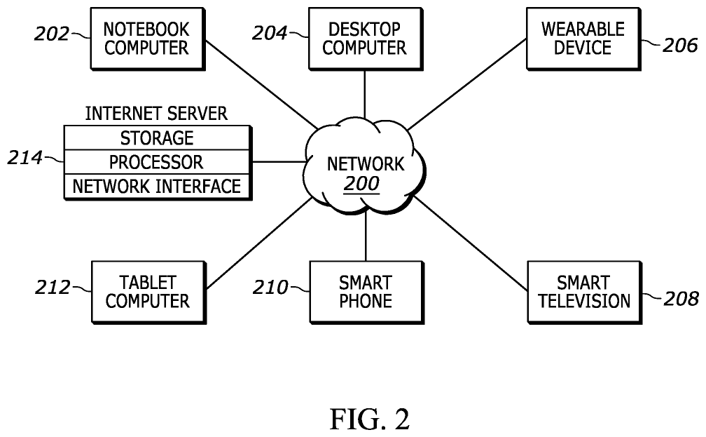

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 may be configured to communicate with each other over the network 200 to undertake present principles.

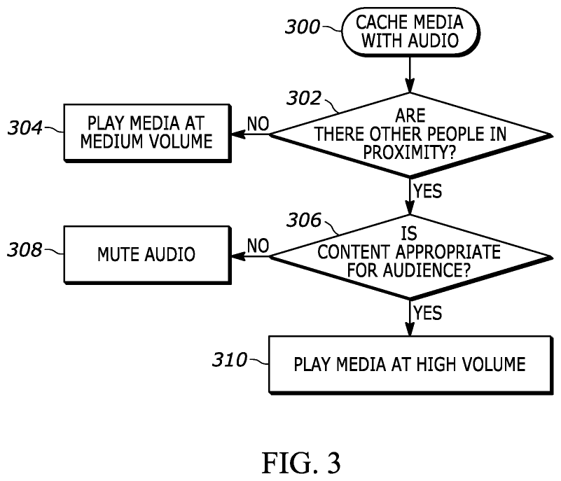

Referring to FIG. 3, it shows example logic that may be executed by a device such as the system 100 in accordance with present principles. Beginning at block 300, the device may access and cache a media file or other content that itself includes audio content. For example, the user of the device may be scrolling through a social media feed until a video with accompanying audio is presented and auto-play of the video is initiated. As another example, the user may have selected a link that was emailed to the user for his/her device to then navigate to a video sharing website to download and view audio video (AV) content. As but one more example, the user may provide a command to view AV content sent to them via text message, accessible over the cloud, or stored locally at his/her device such as if the user took a video with the camera on the device and requested that it be played back at the device.

In any case, once accessed the media content may be cached (e.g., in RAM) prior to presentation at the device. Responsive to being cached, the logic may then move to block 302. At block 302 the device may determine whether other people besides an end-user of the device are present near the device.

For example, a camera on the device may be used to determine, using facial and/or object recognition software, a person indicated in an image from the camera and the distance to the person while also distinguishing the person from the user as also shown in the image based on the device having already pre-registered the user's face for facial recognition. The distance to the person other than the user may then be determined based on the known locations of other items shown in the image and the size of the person's body (or face specifically) in relation to the size of the objects with known locations as shown in the same image. The distance from the device to the person other the user may be determined other ways as well, such as using an IR proximity sensor or laser rangefinder according to the description of FIG. 1 above.

Additionally, in some examples at block 302 the device may determine, based on facial recognition, whether the person is an adult or a person under a predetermined age threshold (e.g., a child under eighteen years old or twenty one years old). Still further, as indicated above in some examples at block 302 the device may use facial recognition to also identify the particular user of the device himself or herself as indicated in the image.

Additionally, in some examples at block 302 the device may then determine whether the person other than the user, at his/her current distance to the device, is within a threshold distance to the device. The threshold distance may be a predetermined threshold of ten feet, for example, as set by a system administrator or the end-user. If the person is determined to be within the threshold distance to the device, the user may be determined to be present near the device. Otherwise, the person may not be determined to be present near the device.

Responsive to a negative determination at block 302, the logic may proceed to block 304. At block 304 the device may present the media file at the device, including the audio content, at a medium or other default normal volume level. Alternatively, the audio content of the media file may be presented at a last-used volume level for the most-recent media file that was presented at the device in the past (e.g., a volume level on a volume level scale from one to ten).

However, responsive to an affirmative determination at block 302, the logic may instead proceed to block 306. At block 306 the device may determine whether the audio content is appropriate for the audience/person other than the user that was determined to be present near the device. Appropriate may be based on a set of rules for various circumstances as might be stored at the device.

For example, responsive to being cached, the audio content of the media file may be analyzed using voice recognition to identify predetermined keywords or topics indicated within the audio content, including words that are spoken or sung within the audio content. The predetermined keywords that might be recognized by the device may include predetermined profane words, words of sexual acts or sexual content, and/or words of violence. The rule set(s) may also indicate the respective audience for which audio indicating those respective keywords can be presented or should not be presented, such as the associated audio not being presented with children under the age of eighteen present (e.g., even if other present people determined to be adults may otherwise hear the audio content with the predetermined keywords according to the rule set) or the audio being presented if a certain predetermined adult person is present (e.g., where adults for which respective faces cannot be recognized may be used to determine to not present the audio).

Note that the predetermined keywords may also include sensitive financial/bank information or personal information (e.g., “social security number”), the word “confidential” itself, loving words from a significant other, etc., and the audience for which audio indicating those words should not be presented may be anyone other than the user himself/herself.

The rule sets themselves may be reflected in a relational database or lookup table that may be accessed by the device, with the relational database or lookup table having the associations between certain keywords and the audiences for which associated audio content can or should not be presented. Also note that the voice recognition software that is used by the device may form part of a digital assistant executing at the device, such as Amazon's Alexa, Google's Assistant, or Apple's Siri.

Still in reference to block 306, in addition to or in lieu of using rule sets, an artificial intelligence-based model may also be used to determine at block 306 whether the content is appropriate for the identified audience. For example, responsive to determining that a child is present, this factor as well as the words recognized from the audio content itself may be provided as input to an artificial neural network having an input layer, output layer, and multiple hidden layers in between that are configured and weighted to make inferences about whether a set of words indicated in the input indicate a predetermined topic for which associated audio should not be presented with a child present (such as violence). To this end, a convolutional or recurrent deep neural network may be used once, for example, a generic speech topic recognizer is adopted as a template and then the neural network is trained in supervised or unsupervised fashion to tailor the neural network to better infer from various words or sentences whatever particular topics the supervisor/administrator desires.

Still in reference to block 306, responsive to an affirmative determination the logic may proceed to block 310 where the device may use a speaker on or in communication with the device to present the media file at the device, including the audio content, at a high or other default normal volume level. Alternatively, the audio content of the media file may be presented at a last-used volume level for the most-recent media file that was presented at the device in the past.

However, responsive to a negative determination at block 306, the logic may instead proceed to block 308. At block 308 the device may either present the media file at the device with the audio content muted/not presented, or the device may present the media file at the device, including the audio content, at a low or other default volume level for sensitive content. But whether the media file is presented with its audio content muted or presented at a low default volume level for sensitive content, in some examples and also at block 308 the device may also present subtitles/closed captioning for the audio content on its display as recognized from the voice recognition analysis so that the user may still be able to appreciate what is being said, sung, referenced, etc. in the audio content.

Now describing FIG. 4, it also shows example logic that may be executed by a device in combination with or separate from the logic of FIG. 3. The logic may begin at block 400 where the device may access audio content similar to as set forth above. The logic may then proceed to block 402 where the device may execute voice recognition to analyze the words of the audio content similar to as set forth above to determine, at decision diamond 404, whether the audio indicates any predetermined keywords that have been flagged for low or muted volume presentation. Again, profane words, words of violence, or words related to sensitive personal information may establish the keywords.

A negative determination at diamond 404 may cause the logic to proceed to block 406. At block 406 the device may determine an ambient noise level around the device based on input from a microphone on or in communication with the device. Ambient noise level may be determined by determining the amplitude of indistinguishable noise signals identified from the microphone input (e.g., indistinguishable using voice recognition). The logic may then proceed to block 408 where the device may access a lookup table or relational database indicating an associated volume level at which to present audio content based on the amplitude of the ambient noise signals, and then present the audio content at the device according to the associated volume level using a speaker on or in communication with the device. Also, if the ambient noise is determined to be above a certain ambient noise threshold for very loud environments, then at block 408 the device may also present subtitles/closed captioning for the audio content on its display as recognized from the voice recognition analysis so that the user may still be able to appreciate what is being said, sung, referenced, etc. in the audio content even if ambient noise is relatively high.

However, in other implementations at block 408 the device may instead not factor in ambient noise and simply present the audio content at a default or preset normal volume level, such as a default level for presentation of non-sensitive audio content or a most-recently used volume level. From block 408 the logic may revert to block 400 to proceed therefrom in order to present other audio content or to present an additional portion of the same audio content that is being or has already been presented.

Referring back to diamond 404, if an affirmative determination is made instead of a negative one, then the logic may proceed to block 410. At block 410 the device may determine the presence of any people besides the user similar to as set forth above already. The logic may then proceed to block 412.

At block 412 the device may determine whether the device is currently disposed in a public or non-pubic location (e.g., private residence). For example, the detection of multiple separate conversations in input from the device's microphone may be used to determine that the device is in a public location, whereas the absence of such conversations may be used to determine that the device is in a non-public location.

As another example, the device may receive GPS coordinates from its GPS transceiver to determine the current location of the device. The device may then access a relational database or map information indicating the location as being associated with a type of establishment associated with being a public location, such as a restaurant or movie theater. Or, the relational database may simply indicate whether the GPS coordinates are associated with a public or non-public location regardless of establishment type.

The foregoing may be useful since whether the current location is public or private may be used by itself (or in combination with other parameters discussed herein, e.g., a child being present) to determine whether audio content that includes a sensitive topic should be presented at a default normal volume level or be muted/presented at relatively low volume level.

From block 412 the logic may then proceed to block 414. At block 414 the device may determine the current ambient noise level similar to as set forth above with respect to block 406. The logic may then proceed to block 416. At block 416 the device may determine a volume level at which to present the audio content based on one or more of the parameters already identified by the device consistent with the description herein. The device may then present the audio at the determined volume level at block 418 using one or more speakers on or in communication with the device. Also at block 418, in some examples the device may also present subtitles/closed captioning for the audio content on its display as recognized from the voice recognition analysis so that the user may still be able to appreciate what is being said, sung, referenced, etc. in the audio content.

For example, if a sensitive topic like war in another country is indicated in the audio content (e.g., a news broadcast) and a child is present, the audio content may be presented at a default “low” volume level preset by a user, but as also adjusted up or down from the default low volume level by a preset amount based on the particular ambient noise amount that is determined to exist at that time. Thus, the user may still hear the audio content notwithstanding ambient noise, but the child may still not hear it or not hear it well enough to decipher what is being said. Accordingly, also note that a relational database or lookup table of volume adjustments up or down (from a default volume level) based on a detected ambient noise level may be used for such purposes. However, also note that in another variation of this example, the audio content may not be presented at all or may be muted rather than being presented at the default low volume level that is still higher than zero.

As another example, if profane language is used and the device is determined to be at a public place, then the audio content may be muted even if associated video content for the same AV file is still presented. However, if profane language is used and the device is either or both of determined to be in a non-public place or in the presence of a predetermined person for which the device already knows volume adjustments down do not need to be made (e.g., the user's adult brother), then the audio content may be presented at a default normal volume level or last-used volume level.

Note that from block 418 the logic may revert to block 400 and proceed therefrom in order to present other audio content or to present an additional portion of the same audio content that is being or has already been presented.

Before moving on in the detailed description, note in reference to both FIGS. 3 and 4 that in some examples some of the steps disclosed above may be performed by a remotely-located server in communication with the end-user's device. For example, the server may analyze the audio content using voice recognition software executing at the server to determine whether profane or other sensitive language is used. The server may then transmit an indication of the profane language or other reasons the audio content has been flagged to the end user's device for the end user's device to then determine whether any other people are present and at which volume level to present the audio content based on that.

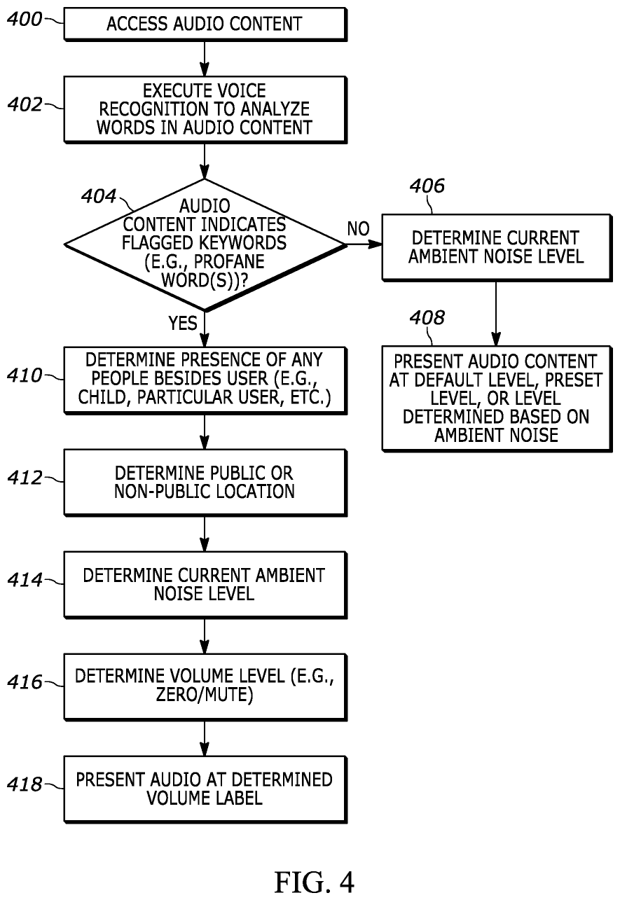

Now in reference to FIG. 5, it shows an example graphical user interface (GUI) 500 that may be presented on the display of a device consistent with present principles. The GUI 500 may be presented, for example, prior to presentation of audio content determined to indicate sensitive information or other keywords for which a default low volume level should be used or for which the audio content should simply be muted. The GUI 500 may thus include an indication 502 including a star icon and text indicating that the audio content to be presented has been flagged for low volume presentation or muting. The GUI 500 may also include text 504 indicating the reason that the audio content has been flagged, which in this case is because the audio contains violent words. But to give the user the option to listen to the audio content anyway, a selector 506 may be presented.

The selector 506 may therefore be selected using touch or cursor input to command the device to present the audio content anyway. In examples where the audio content would otherwise be muted, selection of the selector 506 may command the device to either present the audio content at a default low volume level, or command the device to present the audio content at a default normal or last-used volume level depending on how the user or system administrator might have configured the device. In examples where the audio content would otherwise be presented at a low volume level already based on recognition of the violent content, selection of the selector 506 may command the device to present the audio content at the default normal or last-used volume level.

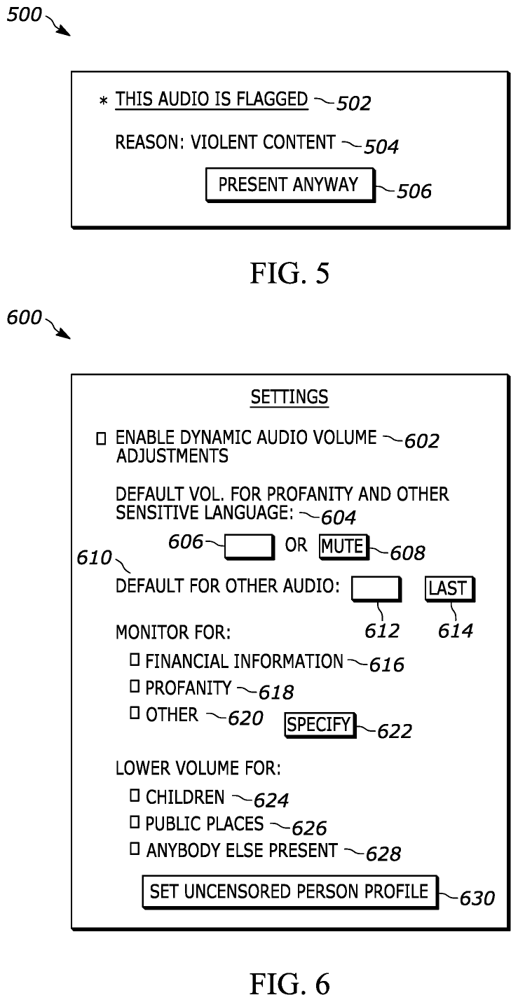

Now describing FIG. 6, it shows an example settings GUI 600 that may be presented on the display of a device configured to undertake present principles. The GUI 600 may thus be presented to configure one or more settings of the device to operate consistent with present principles. The various options of the GUI 600 that will be discussed below may be selected by directing touch or cursor input to the respective adjacent check box.

As shown in FIG. 6, the GUI 600 may include a first option 602 that is selectable to enable or set the device to perform volume adjustments/muting of audio content based on identification of one or more parameters as set forth herein. For example, selection of the option 602 may set the device to undertake the logic of FIGS. 3 and/or 4, as well as to present the GUI 500 of FIG. 5.

The GUI 600 may also include a setting 604 at which the end-user may establish a default low volume level to use for audio content with profanity and other topics/sensitive language. To set the default low volume level, the user may enter a number from a predetermined volume level scale into input box 606 or select the mute selector 608 to establish zero/muting as the default low volume level. If input to the box 606 is used, the scale may be a simple low, medium, high scale, or it may be a scale from zero to ten or another integer.

Similarly, a setting 610 may also be presented with an associated input box 612 at which the user can establish a default normal volume level to use (e.g., as might still be adjusted based on ambient noise that might exist at a given time as discussed above). However, also note that a selector 614 may also be presented for the setting 610. The selector 614 may be selectable to instead set the device to use a most-recently configured volume level as previously set by the end-user for presentation of audio content at the default normal volume level.

If desired, in some implementations the GUI 600 may also include various options 616 and 618 that may be selectable to select various specific types of keywords or topics for which to monitor and either mute associated audio content or present the audio content at the default low volume level. Note that although only two options are shown for financial information and profanity, options for other types of keywords or topics may also be presented including others mentioned herein.

Additionally, note that an option 620 may be presented along with the options 616, 618. The option 620 may be selected via the adjacent check box and then the user may also select the specify selector 622 to cause another GUI to be presented at which a user may enter one or more additional, user-defined keywords or topics for which the user would like the device to monitor audio content so that based on their existence the device may present the associated audio content at the default low volume level or simply mute that audio content.

As also shown in FIG. 6, the GUI 600 may include various options 624, 626, 628 for various parameters for which to monitor and possibly either mute or present audio content at the default low volume level. Example parameters listed on the GUI 600 include children being present, the device being in a public place, and any person other than the user being present (e.g., for situations such as where the user is in a meeting or an academic class). Other parameters as discussed herein may also be listed and only those three are shown in FIG. 6 for simplicity.

Still further, in some examples the GUI 600 may also include a selector 630. The selector 630 may be selectable to initiate a process where the face of a person (other than the user) for which audio content should not be muted or not presented at the default low volume level may be uploaded or provided. Facial recognition data may then be generated as part of a profile for that person, and the profile may then be used by the device at a later time consistent with present principles.

For example, an image of the person's face may be uploaded, or the device's camera may be used to take a picture of the person while the user is going through this process. The user may then provide input indicating whether audio content should be presented at the default normal volume level, or presented at the default low volume level or muted, based on the person's presence being detected. The data may then be stored in a profile for the person for use at a later time consistent with present principles.

However, also note consistent with present principles that a particular person may be identified still other ways besides facial recognition for determining at what volume level to present audio content that might have sensitive content or certain predefined keywords. For example, wireless communication (e.g., Bluetooth communication) with a wearable device already associated with the particular person (e.g., in his/her profile) may be used so that responsive to wireless communication with the wearable device, a received signal strength indicator (RSSI) algorithm may be used to determine whether the wireless signals indicate the wearable device and hence associated person as being within a threshold distance to the user's device to determine whether the other person is present and thus present audio accordingly. However, the absence of signals from the wearable device may also be used to determine that the associated person is not present and then present audio content accordingly. Voice recognition or other biometric methods of person identification, and/or other forms digital footprint identification, may also be used.

Moving on from FIG. 6, it is to be understood consistent with present principles that an age threshold for whether to present audio content with certain flagged keywords as disclosed herein may in some examples relate not to an age under which the audio content should not be presented but to an age over which the audio content should not be presented. For example, the user may provide input to a GUI like the GUI 600 specifying an upper age threshold of sixty five, over which profane audio content or audio content that is sexual in nature should not be presented.

It is to also be understood consistent with present principles that in some implementations, responsive to a command to begin presenting media with audio content that forms a part of it, the device may begin playback of the audio content at a default normal volume level while making the determinations discussed herein to then adjust the volume output level up or down depending on the outcome of the determinations (e.g., who might be present and whether profane language is used). However, in other implementations the device may make the determination(s) first, select a corresponding volume output level, and then begin presenting the audio content at the determined volume level.

It may now be appreciated that present principles provide for an improved computer-based user interface that improves the functionality and ease of use of the devices disclosed herein for presentation of audio content. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A device, comprising:
at least one processor; and
storage accessible to the at least one processor and comprising instructions executable by the at least one processor to:
access audio content;
determine at least a first parameter related to the audio content;
present a graphical user interface (GUI) on a display accessible to the at least one processor, the GUI indicating that the audio content has been flagged based on the first parameter, the GUI presenting a selector that is selectable to command the device to present the audio content anyway;
determine a volume level at which to present the audio content; and
present, using the device and based on selection of the selector, the audio content at the volume level.

2-10. (canceled)

11. A method, comprising:
accessing, at a device, audio content;
presenting a first portion of the audio content at a first volume level;
determining that at least a first parameter related to the audio content exists;
presenting, based on determining that the first parameter exists, a graphical user interface (GUI) on a display, the GUI comprising a selector that is selectable to provide a command to present a second portion of the audio content notwithstanding the first parameter existing;
determining a second volume level at which to present the second portion of the audio content, the second volume level being less than the first volume level; and
presenting, using the device and based on selection of the selector from the GUI, the audio content at the second volume level.

12. The method of claim 11, wherein the first parameter is related to: use of profanity in the audio content, reference to sexual acts in the audio content, reference to sexual topics in the audio content, use of violent language in the audio content, and/or references to violence in the audio content.

15-17. (canceled)

18. At least one computer readable storage medium (CRSM) that is not a transitory signal, the computer readable storage medium comprising instructions executable by at least one processor to:
access, at a device, first audio content;
determine a first volume level at which to present the first audio content;
present, using the device, the first audio content at the first volume level;
determine at least a first parameter related to second audio content;
present, based on the determination of the first parameter, a graphical user interface (GUI) on a display accessible to the at least one processor, the GUI comprising a selector that is selectable to command the at least one processor to present the second audio content;
determine a second volume level at which to present the second audio content; and
present, using the device and based on selection of the selector from the GUI, the second audio content at the second volume level.

19-23. (canceled)

24. The device of claim 1, wherein the GUI indicates via an icon that the audio content has been flagged.

25. The device of claim 1, wherein the GUI indicates via text that the audio content has been flagged.

26. The device of claim 25, wherein the text indicates at least one reason that the audio content has been flagged.

27. The device of claim 26, wherein the at least one reason comprises the audio content including violent content, the violent content satisfying the first parameter.

28. The device of claim 1, wherein the instructions are executable to:
identify a default low volume level greater than zero at which to present the audio content; and
present, based on selection of the selector, the audio content at the default low volume level.

29. The device of claim 28, wherein the GUI is a first GUI, and wherein the instructions are executable to:
present a second GUI on the display, the second GUI comprising a setting at which an end-user can establish the default low volume level.

30. The device of claim 29, wherein the second GUI is different from the first GUI.

31. The device of claim 1, comprising the display.

32. The method of claim 11, wherein the GUI indicates that the audio content has been flagged.

33. The method of claim 32, wherein the GUI indicates via text that the audio content has been flagged.

34. The method of claim 33, wherein the text indicates at least one reason that the audio content has been flagged.

35. The method of claim 11, wherein the GUI is a first GUI, and wherein the method comprises:
presenting a second GUI on the display, the second GUI comprising a setting at which an end-user can establish the second volume level.

36. The method of claim 35, wherein the second GUI is different from the first GUI.

37. The CRSM of claim 18, wherein first audio content and second audio content both form part of a same media file.

38. The CRSM of claim 18, wherein the GUI indicates that the second audio content has been flagged based on the first parameter.

39. The CRSM of claim 18, wherein the second volume level is less than the first volume level.
